(19) United States
(12) Patent Application Publication
(10) Pub. No.: US 2026/0065025 A1
(43) Pub. Date: Mar. 5, 2026

(54) MACHINE LEARNING BASED SIMULATED CONTROL EVALUATION

(71) Applicant: Interstice Labs, Inc. dba Trustero, Palo Alto, CA (US)

(72) Inventors: Phillip Liu, Palo Alto, CA (US); Aleksandr Olegovich Gonopolskiy, Berlin (DE); Martha Raber, Suwanee, GA (US); Nicholas Adam Martin, Beaverton, OR (US); Max Hirsch, Philadelphia, PA (US)

(21) Appl. No.: 19/318,321

(22) Filed: Sep. 3, 2025

Related U.S. Application Data
(60) Provisional application No. 63/690,755, filed on Sep. 4, 2024.

(51) Int. Cl. G06N 3/0455; G06N 3/092; G06N 3/096

(52) U.S. Cl. CPC G06N 3/0455; G06N 3/092; G06N 3/096

(57) ABSTRACT

A system evaluates controls established for an organization. The system receives a description of a set of controls and a set of constraints. The system identifies a set of data sources storing information associated with the set of controls. The system stores vector representations of information obtained from the set of data sources in a vector database. For each control from the set of controls, the system extracts supporting information related to the control from the vector database based on vector distances. The system generates a structured query input describing the control and the supporting information, and inputs the structured query input into the trained transformer-based neural network. The system processes the output sequence generated by the trained transformer-based neural network to obtain a result indicating whether the control satisfies a constraint from the set of constraints. The system evaluates the set of controls based on the results.

### CROSS REFERENCE TO RELATED APPLICATION

This application claims the benefit of and priority to U.S. Provisional Application No. 63/690,755, filed Sep. 4, 2024, which is incorporated by reference herein in its entirety.

### BACKGROUND

The disclosure relates to using machine learning based language model for evaluation of service controls for systems of an organization.

Organizations delegate controls on services used by the organization to safeguard privacy and security of user data stored and processed by the organization. The controls may be used to ensure security, availability, privacy, and so on for data processed and for the technology used by the organization. For example, security controls may ensure that malicious users are not able to get unauthorized access to the computing resources and data stored by the organization. The organization may require controls related to confidentiality that determines the users who are allows data access. Similarly, organization may require controls for ensuring privacy of personal information of users. An organization may be a multi-tenant system that stores and processes data for multiple tenants. The multi-tenant system needs to implement controls to provide assurance to tenant systems that their data is being maintained securely. An organization needs to ensure that the service controls are in compliance with any policies implemented by the organization.

### SUMMARY

Embodiments concern evaluation of controls established for an organization, for example, for systems of an organization. The system receives a description of a set of controls and a set of constraints. The system identifies a set of data sources storing information associated with the set of controls. The system stores vector representations of information obtained from the set of data sources in a vector database. For each control from the set of controls, the system extracts supporting information related to the control from the vector database based on vector distances. The system generates a structured query input describing the control and the supporting information, the structured query input formatted according to a pre-defined schema for interaction with a trained transformer-based neural network and inputs the structured query input into the trained transformer-based neural network. The system processes an output sequence generated by the trained transformer-based neural network to obtain a result indicating whether the control satisfies a constraint from the set of constraints. The system generates evaluation of the set of controls based on results obtained for the set of controls and performs a target action based on the evaluation of the set of controls.

Embodiments concern efficient execution of control tests for an organization. The system receives description of a set of controls. The system identifies a set of control tests associated with the controls. For each control, the system collects supporting information for the control. For each control test, the system performs the following steps. The system determines whether supporting information indicates that a condition required by the control failed to occur. The system determines whether the supporting information is applicable to the control test. The system determines whether the supporting information passes the control test. The system builds an output data structure representing a result of the control test. The system determines a final result by summarizing a set of results obtained from the set of control tests and performing a target action based on the final result. For example, the system may generate a report and send to one or more client devices.

Embodiments concern efficient summarization of results of evaluation of controls established for an organization, for example, for systems of an organization. The system receives description of a set of controls. The system identifies a set of control tests associated with the set of controls. The system collects a set of supporting information related to the set of controls. For each supporting information and for each control test, the system evaluates the supporting information with respect to the control test. For each control test from the set of control tests, the system summarizes results of evaluating each supporting information applicable to the control test with respect to the control test. For each control test group, the system obtains a control test group result by summarizing results of control tests belonging to the control test group. The system summarizes all control test group results to obtain an overall summarization result. The system performs an action based on the overall summarization result, for example, by scheduling an event or sending the overall summarization result to a client device.

According to an embodiment, the steps described herein are executed as a process. According to an embodiment, a non-transitory computer readable storage medium comprising stored program code including instructions that when executed by one or more computer processors, cause the one or more computer processors to perform the steps of the methods described herein. Other embodiments include computer systems that include one or more processors and a non-transitory computer readable storage medium comprising stored program code including instructions that when executed by the one or more computer processors, cause the one or more computer processors to perform the steps of the methods described herein.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 shows the overall system environment for analyzing service controls for an organization, according to an embodiment.

FIG. 2 shows the system architecture of the service control analysis system 100, according to an embodiment.

FIG. 3 shows a flowchart illustrating the process for extracting a library of service controls, according to an embodiment.

FIG. 4 shows a flowchart illustrating the process for determining representative service controls for categories of external services, according to an embodiment.

FIG. 5 shows a flowchart illustrating the process for determining service controls for an organization using the library of service controls, according to an embodiment.

FIG. 6 shows a flowchart illustrating the process for extracting a library of service control tests, according to an embodiment.

FIG. 7 shows a flowchart illustrating the process for determining service control tests for an organization using the library of service control tests, according to an embodiment.

FIG. 8 shows a block diagram illustrating the approach of testing for AI based compliance audit, in accordance with an embodiment.

FIG. 9 shows a flow chart illustrating two phase analysis of controls for performing an AI based compliance audit, in accordance with an embodiment.

FIG. 10A shows a diagram illustrating the pre-audit phase of AI based compliance audit, in accordance with an embodiment.

FIG. 10B shows a diagram illustrating the audit phase of AI based compliance audit, in accordance with an embodiment.

FIG. 11 is a flowchart illustrating an overall process of performing AI based compliance audit, according to an embodiment.

FIG. 12 shows a flowchart illustrating a process for efficiently performing AI based compliance audit, according to an embodiment.

FIG. 14 illustrates a tree data structure for storing summaries for performing spot check, in accordance with an embodiment.

FIG. 15 shows the overall process of summarization of control test results, according to an embodiment.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### DETAILED DESCRIPTION

### Overall System Environment

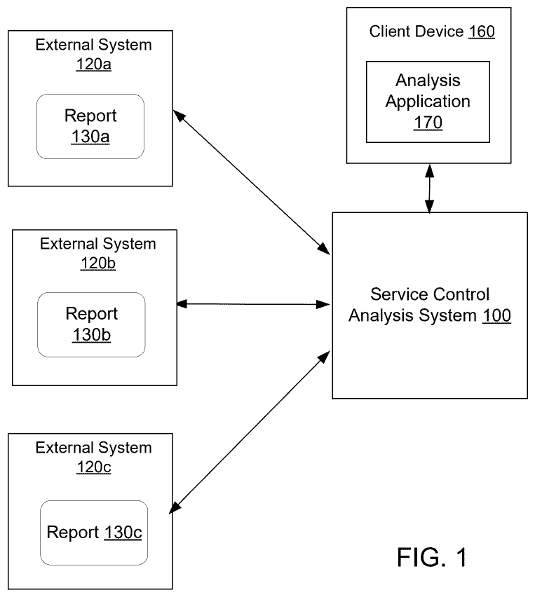

FIG. 1 shows the overall system environment for analyzing service controls for an organization, according to an embodiment. The overall system environment includes a service control analysis system 100, one or more external systems 120, and a client device 160. In other embodiments, more or less components than those indicated in FIG. 1 may be used. For example, external systems 120, client device 160, and reporting system 150 may interact with service control analysis system 100 via a network (not shown in FIG. 1). Furthermore, there may be more or less instances of each system shown in FIG. 1, for example, there may be multiple client devices 160. A service control is also referred to herein as a control.

The service control analysis system 100 receives documents representing reports from one or more external systems. These reports describe service controls associated with other organizations. The service control analysis system 100 analyzes the received reports to determine a mapping from categories of services to service controls and mappings from service controls to service control tests. A service control test is also referred to herein as a control test. The service control analysis system 100 allows organizations to use the extracted information for determining service controls and service control tests for services they are providing. For example, an organization may use the analysis application 170 running on a client device 160 to provide description of services they offer and analyze them. The service control analysis system 100 analyzes the received description of services to provide description of service controls and service control tests associated with the services specified. In an embodiment, the service control analysis system 100 automatically generates a report or portions of a report describing the service controls for the organization.

FIG. 1 and the other figures use like reference numerals to identify like elements. A letter after a reference numeral, such as “130a,” indicates that the text refers specifically to the element having that particular reference numeral. A reference numeral in the text without a following letter, such as “130,” refers to any or all of the elements in the figures bearing that reference numeral (e.g. “130” in the text refers to reference numerals “130a” and/or “130b” in the figures).

### System Architecture of the Service Control Analysis System

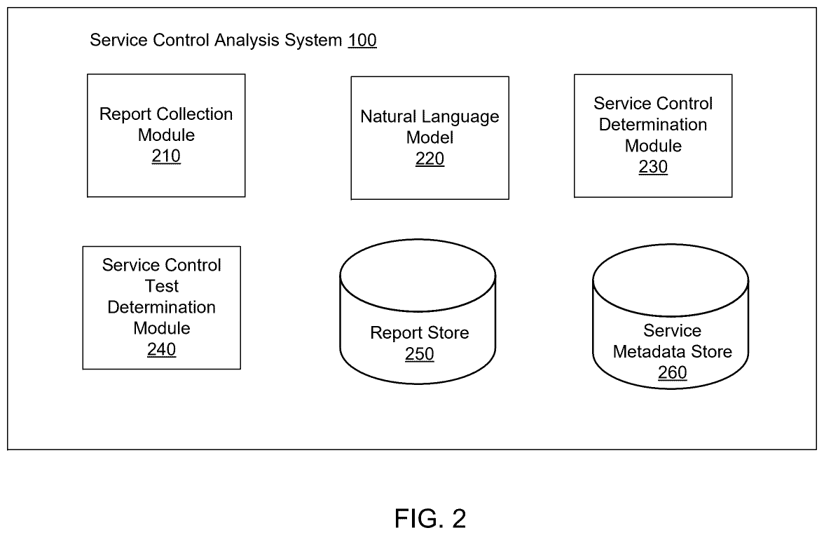

FIG. 2 shows the system architecture of the service control analysis system 100, according to an embodiment. The service control analysis system 100 includes a report collection module 210, a natural language model 220, a service control determination module 230, a service test determination module 240, a report store 250, and a service metadata store 260. In other embodiments, the service control analysis system 100 may include other modules not described herein. Functionality indicated as provided by a particular module may be implemented by other modules instead.

The report collection module 210 collects documents representing reports from external systems 120. The report collection module 210 may crawl the websites of various external systems to identify the reports. In an embodiment, the collection of some of the reports may be performed by a user. Alternatively, a list of URLs (uniform resource locators) is provided as input to the report collection module 210 and the report collection module 210 accesses the URLs to get web pages that are further analyzed to identify reports that are further downloaded. The reports downloaded are stored in the report store 250,

The natural language model 220 receives an input natural language text and encodes the input natural language text to generate an encoded representation of the input natural language text, for example, a vector of numerical values representing features describing the input natural language text. In an embodiment, the natural language model is a neural network but is not limited to neural networks. The natural language model takes text represented in natural language as input and generates an encoding of the input natural language text. For example, the natural language model may receive as input a natural language sentence representing a service control and generate an encoding of the input natural language sentence. The encoding of the input natural language sentence may be a vector representation of a set of features describing the input natural language sentence. In an embodiment, the natural language model is an autoencoder that receives an input natural language sentence, generates an encoded representation of the input natural language sentence, and generates an output that matches the input natural language sentence from the encoded representation. The natural language model is trained using several natural language sentences.

The service control determination module 230 receives description of services of an organization and determines service controls associated with the services. In an embodiment, the service controls correspond to external services that may be invoked by the services of the organization. The service controls represent service controls extracted from documents collected from external systems. Examples of service controls include natural language sentences such as “All accesses to the system are logged by the system and stored in digital format”, “Data center service room is equipped with access security system,” “video data from surveillance cameras is recorded and archived for future use,” “computer equipment is located in locked cabinets”, “physical access to data center is reviewed in a monthly basis, “physical access points to server locations are managed by electronic access control devices,” “electronic intrusion detection systems are installed in data server locations,” and so on.

The service test determination module 240 receives description of services of an organization and determines service control tests associated with the services. In an embodiment, the service control tests correspond to external services that may be invoked by the services of the organization. The service control tests represent service controls extracted from documents collected from external systems.

The service metadata store 260 stores metadata describing services. A service may be a service of an organization of an external service invoked by a service of the organization. The service metadata store 260 stores categories describing external services. Examples of categories of external services include a category of storage services, a category of compute services, a category of networking services, a category of document processing services, a category of CI/CD (continuous integration/continuous delivery) provider services (for example, GitHub), and so on.

### Processes for Determining Service Controls

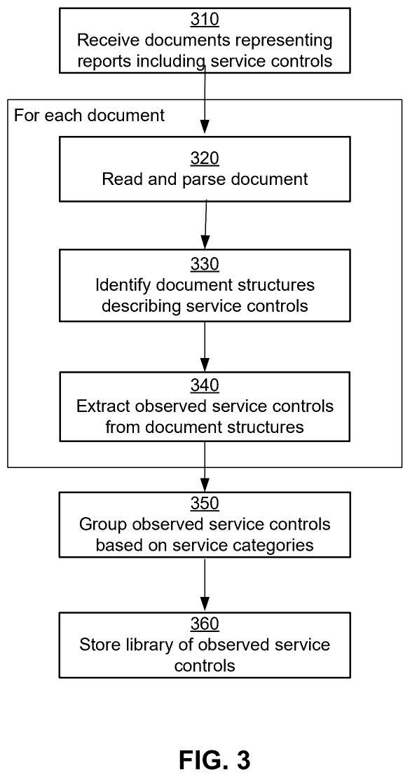

Various processes are described herein that are executed by the service control analysis system 100 for determining service controls for an organization, for example, processes illustrated in FIGS. 3-5. The steps of the processes described herein may be executed in an order different from that indicated herein. The steps are described as being performed by a system, for example, the service control analysis system 100 and may be performed by various modules of the service control analysis system 100.

FIG. 3 shows a flowchart illustrating the process for extracting a library of service controls, according to an embodiment. The system, for example, the service control analysis system 100 obtains documents representing reports and builds a libraries of observed service controls based on information obtained from the documents.

The system receives 310 documents representing reports describing service controls that for various services. The documents may represent reports obtained from external system 120 that correspond to organizations that prepared the reports describing service controls that they identified in connection with services implemented by the organizations. In an embodiment, the documents are PDF (portable document format) documents but may be represented using any other document format, for example, JSON (JavaScript object notation) format, Microsoft WORD format, postscript format, and so on.

The system performs steps 320, 330, and 340 for each document received 310. The system reads and parses 320 the document. In an embodiment, the system includes parsers for various formats of documents and invokes the appropriate parser matching the format of the document.

In an embodiment, the system builds a data representation of the document. The data representation stores information describing various portions of the document using data structures that are easy to process. The system may store rules defining the portions of the documents that describe service controls of external services. In an embodiment, the rules specify regular expressions that match portions of the documents. The regular expressions may match section headings of various section of the document. Some regular expression may match table headings and or table column headers of tables stored in the document. For example, the document may store a table that includes a column identifying a service category and a column identifying the service controls corresponding to each service category. The regular expressions may match expected column headings to determine which column of the table represents the service category and which column represents service controls. For example, a regular expression “*subservice organization*” matching table headings may be used to identify the table storing service control information, a regular expression “*control*” matching column headings may be used to identify columns representing service controls and a regular expression “*category*” matching column headings may be used to identify the column storing service category. The regular expression matches may be performed in a case insensitive manner. In an embodiment, the system stores a set of regular expressions for identifying each portion of the documents. The set of regular expressions may be provided by an expert and may be obtained from documents that were previously analyzed. The set of regular expressions may be updated as new documents are obtained, for example, by adding new regular expressions, modifying existing regular expressions, and so on.

The system identifies 330 the data structures that represent the information describing the service controls corresponding to external services used by the organization that provided the document. Examples of data structures include tables stored in documents, sections of the documents, and so on. The system extracts 340 the information describing the service controls used by external services from the identified 330 data structures. Each service control may be represented as one or more natural language sentences. The system may process a natural language sentence to normalize the sentence and keywords used in the sentence.

The system groups 350 the service controls based on categories of external services. The system may store a few hundred service controls for each service category. The set of service controls may be growing over time as new documents are received and processed by the system. The service controls extracted from the documents are also referred to as observed service controls.

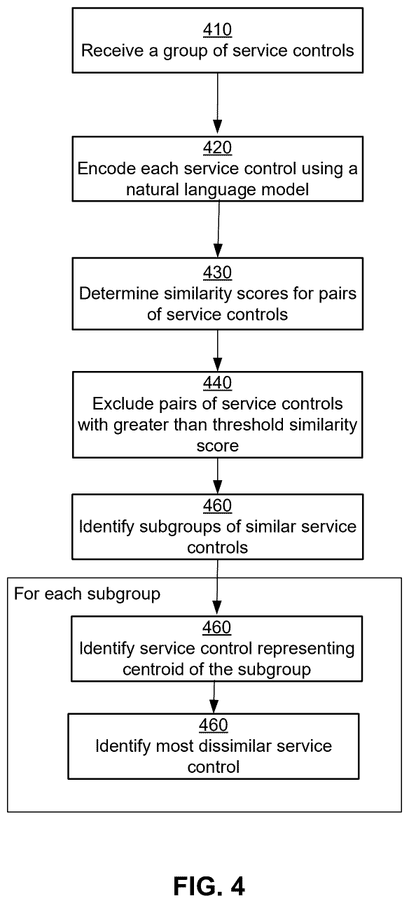

The system stores 360 a library of observed service controls based on the information extracted from the documents. In an embodiment, the library of observed service controls stores a mapping from various service groups to service controls. This mapping may be referred to as the service control mapping. The library may store the service control mapping along with the library of observed service controls. The system further processes the information stored in the library of observed service controls using processed such as the process described in FIG. 4.

FIG. 4 shows a flowchart illustrating the process for determining representative service controls for categories of external services, according to an embodiment. The process illustrated in FIG. 4 may be used for processing a group of service controls, for example, a set of service controls corresponding to a category of external services or a set of service controls corresponding to an external service.

The system receives 410 a group of service controls. The received group of service controls may represent all service controls corresponding to a category of external services. The system accesses a natural language model for encoding the service controls and encodes 420 each service control using the natural language model.

The system uses the encoded representations of the service controls to compare service controls. The system determines 430 similarity scores for pairs of service controls. The similarity score may be determined using vector operation performed on a pair of input encoded representations of service controls. For example, the system may determine a cosine similarity of two vectors to determine similarity score of the two vectors. The cosine similarity of two vectors is determined as the dot product of the two vectors divided by the product of the magnitude of the two vectors.

In an embodiment, the system creates a similarity matrix M_{S} that stores similarity scores for each pair of service controls. For example, if there are N service controls, the similarity matrix is of size N×N and stores a similarity score for each pair of service controls.

The system selects a subset of the pairs of service controls that indicate higher measure of similarity compared to other pairs. For example, the system uses a threshold similarity score (i.e., a cut off similarity score value, for example, a value of 0.8 or 0.7 or 0.6) and excludes all pairs of service controls that have similarity score below the threshold similarity score. The threshold similarity score may be a configurable value that may be determined experimentally or specified by an expert. The system excludes 440 pairs of service controls from the similarity matrix that have similarity score below the threshold similarity score to create an adjacency matrix M_{A}. The adjacency matrix M_{A} represents pairs of service controls that have higher measure of similarity on an average compared to the pairs of service controls of the similarity matrix M_{S}. The system uses the adjacency matrix M_{A} as a representation of a graph G of similar service controls within the input group of service controls.

The system identifies 460 sub-groups of similar service controls from the input group of service controls using the graph representation G of service controls based on the adjacency matrix M_{A}. In an embodiment, the system selects cliques within the graph G, where a clique represents a subgraph with all nodes connected to other nodes of the subgraph. The system may use any other measure of closely connected subgraphs within the graph G that represent a cluster of similar service controls identified within the received group of service controls.

The system identifies representative service controls for each sub-group of service controls. The system identifies 460 a service control representing the centroid of the sub-group. The centroid of the sub-group represents the most central service control within the sub-group. Accordingly, the system determines a subset of service controls that represent the group of service controls corresponding to a category of external services. For example, if the input group has a couple of hundred service controls, the system selects approximately 3 to 10 representative service controls corresponding to the category of external services. In an embodiment, the system further identifies a service control that is most dissimilar compared to the centroid service control. The system selects that service control that has the smallest similarity score compared to the centroid service control. The system uses the centroid service control and the service control that is most dissimilar to the centroid service control as the representative service controls of a sub-group or the received group.

In an embodiment, the system further uses the natural language model to summarize the group of service controls by selecting 2 or 3 most salient service controls from the group even further. According to an embodiment, the system uses a transformer model that is modified to generate summaries given a number of sentences. In an embodiment, the system generates a summary comprising a paragraph by picking the most salient sentences. The transformer model may be a trained transformer-based neural network.

The system stores the representative service controls for various external services or categories of external services in the library of observed service controls. The system uses the library of observed service controls to select and recommend service controls for groups of services obtained from organizations.

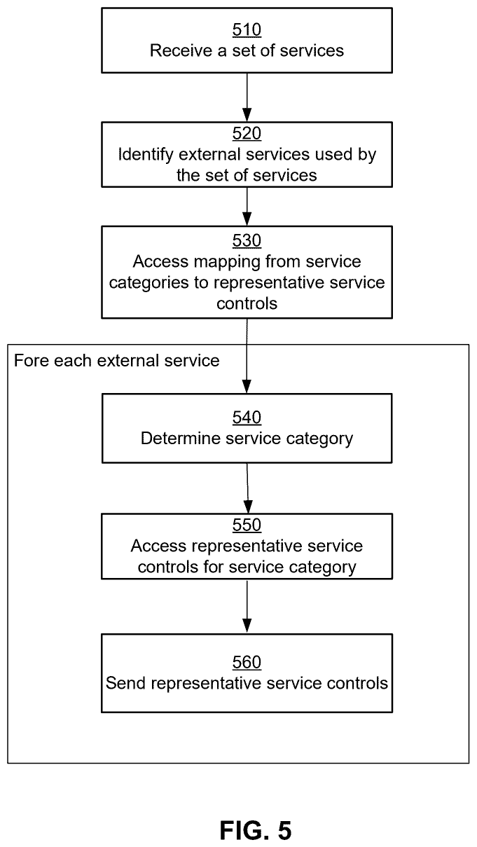

FIG. 5 shows a flowchart illustrating the process for determining service controls for an organization using the library of service controls, according to an embodiment. The system receives 510 a set of services, for example, set of services used by an organization. The system identifies 520 external services invoked by services used by the organization. For example, some of the services used by the organization may use one or more external services. The identifies all the external services used by the organization.

The system accesses 530 a mapping from categories of external services to representative service controls from the library of observed service controls. The system repeats the steps 540, 550, and 560 for each external service identified 520. The system determines 540 a service category for the external service. The system accesses 550 the representative service controls for the determined service category from the mapping. The system sends 560 the accessed representative service controls for the identified external services, for example, for display via a user interface of an application. The system may store accessed representative service controls for the identified external services in a data representation, for example, a data store. In an embodiment, the system automatically generates a report (or a portion of a report) for the organization based on the accessed representative service controls.

### Processes for Determining Service Control Tests

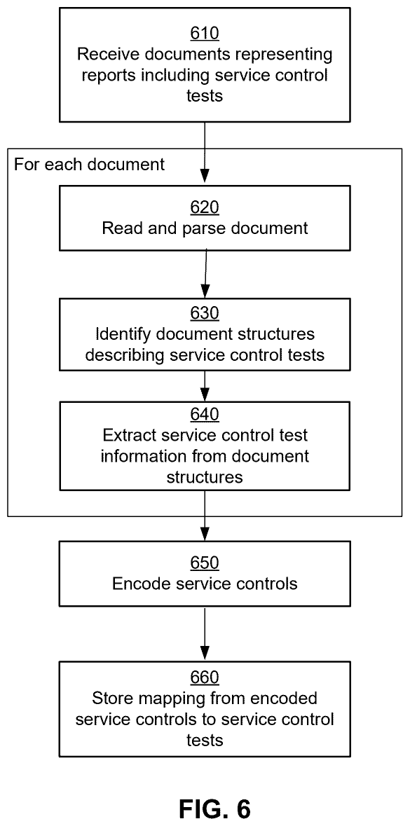

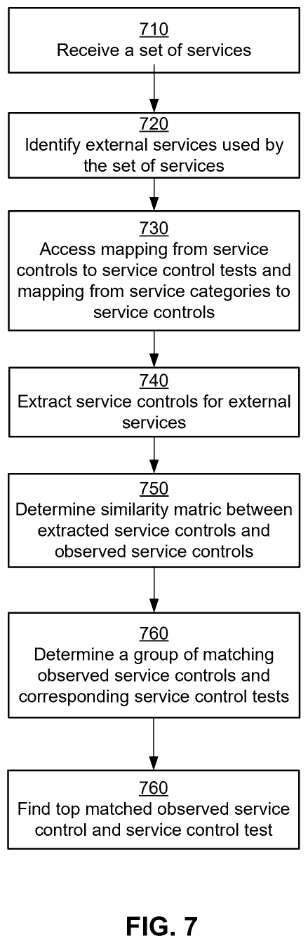

Various processes are described herein that are executed by the service control analysis system 100 for determining service control tests for an organization, for example, processes illustrated in FIGS. 6-7. The steps of the processes described herein may be executed in an order different from that indicated herein. The steps are described as being performed by a system, for example, the service control analysis system 100 and may be performed by various modules of the service control analysis system 100. The service control tests are extracted from documents such as reports obtained from external systems. The service control tests may be represented as natural language text, for example, sentences or phrases. Examples of tests include “inspect a sample of emails to determine that users were directed with appropriate information,” “inspect internal control matrix to determine that tasks were appropriately assigned,” “inspect risk management policies to determine that risk assessment was performed on a regular basis,” and so on. These service control tests represent tests that may have been previously implemented, for example, by auditors of organizations corresponding to the external system from where reports were obtained.

FIG. 6 shows a flowchart illustrating the process for extracting a library of service control tests, according to an embodiment. The system receives reports and analyzes them to extract service control tests. The extracted service control tests are used for determining service control tests for organizations.

The system receives 610 documents representing reports describing various information related to service controls including service control tests. The system performs the steps 620, 630, and 640 for each document received. The system reads and parses 620 the document received. The system identifies 640 document structures occurring in certain portions of the document describing service control tests. In an embodiment, the system searches for specific sections of the document that are determined to include the service control test information. These sections may be identified based on section numbers of sections known to describe the information. In an embodiment, the system identifies these sections by searching for specific keywords or phrases in the section title, for example, keywords “tests”, “service tests”, “test results”, and so on.

The data structure extracted may represent a table included in the document that comprises columns and rows. The system extracts the different columns by performing matches with predefined regular expressions. In an embodiment, the system extracts columns representing service category, service control tests, and service control test results. For example, a regular expression ‘*test results*’ matching table headings may be used to identify the table storing service control test information, a regular expression ‘*control*’ matching column headings may be used to identify columns representing service controls, a regular expression ‘*test*’ matching column headings may be used to identify the column storing service control tests, and a regular expression ‘*results*’ or ‘*test results*’ matching column headings may be used to identify the column storing service control test results.

The system extracts 640 information describing service control tests from the identified document structures. Accordingly, the system stores a service control test mapping that maps service controls to service control tests. A service control test may be stored as one or more natural language sentences. The system uses the service control test mapping to determine service control tests for a set of services provided by an organization. In some embodiments, a process similar to that illustrated in FIG. 4 is used to group service controls and their associated service control tests.

In some embodiments, the process illustrated in FIG. 4 is used to group service controls and their associated service control tests. A process according to another embodiment is illustrated in FIG. 7.

FIG. 7 shows a flowchart illustrating the process for determining service control tests for an organization using the library of service control tests, according to an embodiment. The system receives 710 a set of services associated with an organization. The system identifies 720 external services used by the set of services. Steps 710 and 720 are similar to steps 510 and 520 of the process illustrated in FIG. 5.

The system accesses 730 the service control test mapping that maps service controls to service control tests as determined by the process illustrated in FIG. 6. The system also accesses the mapping from service categories to the service controls as determined by the process illustrated in FIGS. 3-4. The system determines 740 the service controls for the external services, for example, using the service control mapping, using steps of the process illustrated in FIG. 5. The set of extracted service controls may be referred to as set S1. The set of service controls in the service control test mapping is referred to as set S2 or observed service controls.

The system determines 750 values of a similarity metric for pairs of service control (C1, C2) such that C1 represents an extracted service control from set S1 and C2 represents an observed service control from set S2. In an embodiment, the system uses the natural language models to encode the service controls and uses similarity metrics between pairs of encoded service controls, for example, cosine similarity metrics as described herein.

Based on the similarity metric values, the system selects 760 a group of matching observed service controls with corresponding service control tests. In an embodiment, the system uses a similarity threshold and excludes pairs (C1, C2) that have similarity metric values indicating less than the similarity threshold.

The system determines the top matched observed service controls and corresponding service control tests from the group of matching observed service controls with corresponding service control tests. In an embodiment, the system further finds the maximally different control from the top match, thereby obtaining two representative service controls and service control texts including: (1) the best matching service control and service control texts and (2) the service control that is maximally different from the best matching service control as well the corresponding service control texts.

The system sends the representative service controls and their corresponding service control tests as recommended service control tests, for example, for display via a user interface. Accordingly, the system provides past service control tests that were used for other organizations for similar service controls. This provides organizations with information on expected service tests for services that they provide. The system may store the set of service control tests for the identified external services in a data representation, for example, a data store. In an embodiment, the system automatically generates a report (or a portion of a report) for the organization based on the accessed service control tests.

### Artificial Intelligence Based Compliance Audit

The system according to an embodiment, uses RAG (Retrieval Augmented Generation) techniques to examine heterogenous document types on a control-by-control basis to perform tests on controls. The system performs following tasks: (1) Conducts automated audits and notifies departments of their compliance failures; (2) Automatically maps internal processes to the compliance requirements they satisfy; (3) Recommends policies and processes based on industry best practices and a business's existing tools; (4) Detects compliance requirement failures on-demand so departments can quickly remediate before losing customer confidence; and (5) Automatically collects relevant evidence to prove compliance.

The system uses AI trained in information security and compliance to simulate the process used by and actions performed by human auditors. It automatically provides a comprehensive view into an organization's security posture long before they are finally audited by the human auditors who issue their report(s). For information security professionals who deal with security compliance and audits, the system provides the baseline data they need before embarking on a compliance journey and gives them the ability to check their progress along the way. For auditors, it serves as an efficiency and accuracy tool that can quickly verify pre-audit work. Without the simulated audit performed by the system, the organization may identify various issues during an actual audit that may result compliance failure as well as significant waste of human and computing resources in fixing the compliance issues at a late stage.

The system obtains evidence representing information, which may be gathered automatically or manually, that supports an organization's assertion that a control is in place and effective. Evidence may also be referred to as supporting information. The system is able to process heterogeneous forms of evidence that could include, but is not limited to, configuration information about systems, screenshots from systems that can provide relevant information, documents, links to documents, emails, or in information gathered through person-to-person discussions.

Controls are mechanisms including processes, tools, and other techniques implemented by an organization to ensure that all policies and constraints established by the organization are enforced and various users and systems of the organization comply with the policies or constraints of the organization. A control can take various forms such as: limiting access, documenting a process, or ensuring contingency plans that are up to date. Controls are used to bring an organization into alignment with auditing frameworks, such as SOC 2. Controls may be represented as records stored databases.

A policy of an organization, a group of users and/or systems is a system of guidelines. A policy may be a high-level description of an organization's intentions, principles, and requirements for a particular area. A policy may be represented as one or more constraints. For example, an organization ensures that certain set of constraints representing policies are satisfied. In the context of compliance, policies should be backed with routine actions tracked by controls. Policies establish credibility of the organization and form the basis on which an auditor assesses controls.

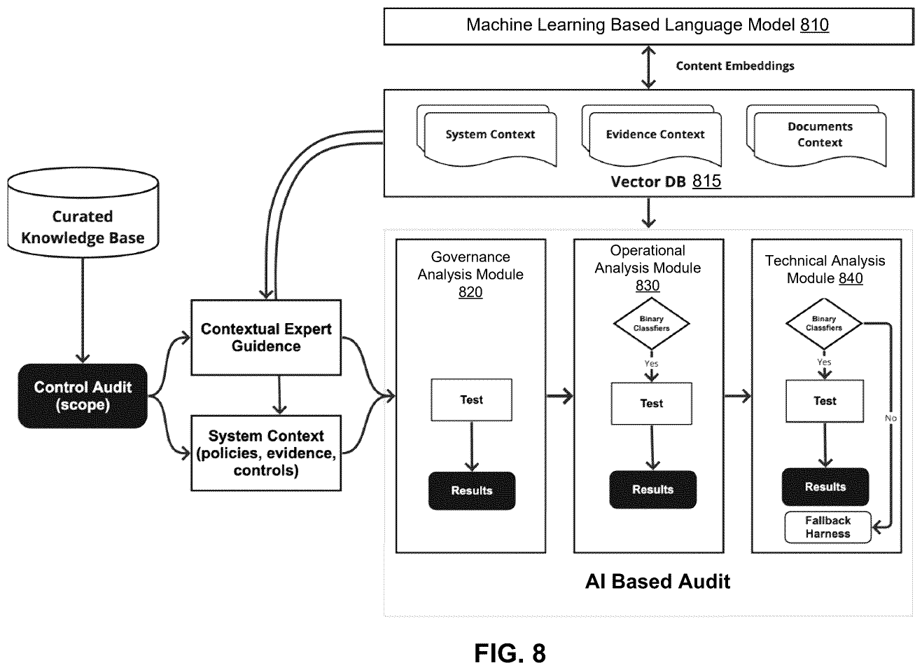

FIG. 8 shows a block diagram illustrating the approach of testing for AI based compliance audit, in accordance with an embodiment. A control has multiple layers including, governance, operational, and technical, each layer implemented using an analysis module.

The governance layer implemented by governance analysis module 820 examines the policy linked to each control and extracts contextual information from relevant documents or other data sources based on similarity to the control objective. This allows the system to reason about particular aspects of these documents and determine whether the policy and control are in agreement.

The second layer is the operational layer implemented by operational analysis module 820. Similar to the governance layer, the purpose of the operational layer is to validate a set of specific documents linked to controls. The particular context needed for this set of tests is the system description and the supporting documents, extracting relevant information from both in order to verify that specific requirements are met within the documents.

The third layer is the technical layer implemented by technical analysis module 820, that verifies the particulars of each control. Each test attempts to identify the sample population of entities that needs to be tested, e.g., a set of employees, a set of sensors, a set of systems, and so on. The test verifies that the control is followed by cross-referencing this sample against other provided information. Each piece of evidence can provide some information. The result of cross referencing is aggregated and summarized in order to make a reasoned decision about the control. At each step of this process, the system uses a context database to augment the prompts provided to machine learning based language model with necessary contextual information to increase the reliability and accuracy results obtained from the machine learning based language model. Furthermore, the system uses chain of thought prompting throughout the entire process to increase accuracy.

The system according to an embodiment simulates a compliance audit of an organization or a team or any group of people or systems by examining a collection of relevant controls required to satisfy a compliance framework requirement such as SOC (System and Organization Controls) 2 Type 2. Following is an example of analysis performed by the system for one particular control's operational effectiveness. From the system's perspective, a control is defined by its objective statement. The control objective examined in this example is: “During coding and prior to code being operational, secure programming techniques are used: peer review and approval, security iterations and test-driven development.” Accordingly, the control may represent mechanisms implemented for software development using tools such as code repositories, version controls, and so on.

The system begins the assessment by gathering data in support of the control and creating a context for examinations. Based on this control objective sentence the system automatically links this control to its related policy, e.g., the secure development policy. The system further links the control to the framework requirement it satisfies, for example, specific compliance criteria such as the SOC 2 Trust Service Criteria. Next, the system gathers evidence or supporting information required to prove the control is implemented.

According to an embodiment, the system gathers the system description provided by the user, itemizes SaaS (software as a service) and software used by the system, and expert knowledge on procedures various organizations use to satisfy the control. Based on the objective and tools used by the user, the system understands that a list of pull requests (PR) should be gathered from the source code version control system used to be examined. Further, the system understands the user uses Jira to track security iteration events and a list of Jira tickets should be gathered for examination. PRs and Jira tickets are considered evidence and evidence is gathered automatically by the system or manually provided by the user. The system is multi-modal since it can process evidence in various forms from a heterogenous set of data sources. For example, evidence may be represented in structured format collected by users or unstructured format such as a screenshot of Jira uploaded by a user.

After all the evidence has been collected the system performs the examination. First, the governance layer examination is performed. The system begins by examining the secure development policy in order to understand that related control objectives are in agreement. The system indexes the gathered context and extracts relevant portions for examination. Concretely, the extracted information is any portion of the policy that relates to peer review, security iterations, test-driven development, services the system uses to perform these tasks, and general guidance around this type of control from the knowledge base. All this information is fed into the machine learning based language model 810 (e.g., a large language model or LLM) to assess (1) whether the policy and the control are in agreement, (2) whether the policy contains all the necessary details, and (3) whether the policy is appropriately scoped to the system.

Next the system performs the operational layer examinations. This layer is concerned with examining supporting documents. In this case, the control is specific to the development process, it does not include specific supporting documents such as a disaster recovery plan, business continuity plan, etc. The system is able to classify this control as not related to these documents and thus this layer does not need to perform a detailed examination.

Next the system performs technical layer examinations. The system runs a series of classifiers to determine which tests are applicable. For example, the system may determine whether a control is related to asset management? The system classifies this control as a change management control and thus it performs a series of tests designed to examine change management control. The system begins the change management control examination by assessing if the evidence set is sufficient to perform a more detailed assessment. According to an embodiment, the system performs the series of tests for all controls.

The system uses the indexed system description, the expert knowledge base, and the policy to assess if the evidence supplied is sufficient. This allows the system to understand: if a user is using GitHub, the system should expect GitHub pull requests (PR) as evidence, and if they use Jira, the system should expect associated tickets. Once the system establishes that the evidence is most likely sufficient, the system proceeds with the technical verification of the control. Each technical control is structured into 3 parts: the applicability classifier, the population sample, and the cross-reference verification. In this case, the system already classified the control as positive so it moves on to the population sample. The system attempts to identify which is the set of PRs in question by estimating which is the most likely PR evidence, and sampling a few PRs from this PR evidence list.

The system samples available supporting information to select a subset of available supporting information or evidence. Next the system uses this sample to cross-reference against other pieces of evidence. In this example, the system would examine the list of PRs and cross-reference it against the optical character recognized (OCR) Jira tickets, validating that the ticketing system corresponds to the PRs and checking that the PRs have an appropriate number of reviewers and code tests applied. The cross-reference between GitHub PR and Jira ticket satisfies the detailed procedure described in the secure development policy where a change requirement is tracked in a Jira ticket and corresponding remediation is tracked in a GitHub PR.

A machine learning based language model may have a context window that limits the size of the input data that can be provided as input to the machine learning based language model for processing. The system limits the size of the input by sampling the supporting information. The system determines the sampling technique based on the type of data. For example, the system may use a particular sampling technique for unstructured data and a different sampling technique for structured data. The sampling technique may depend on the format of the data also. For example, tabular data may be sampled differently from XML (extensible markup language) data. For example, for tabular data the simple may sample different rows of the tabular data. For XML documents the system may sample different tags differently depending on the relative size of that tag. Alternatively, the system may sample different pages differently depending on the relative size of the page. The XML document may represent logs generated by the system. Similarly tabular data may represent records stored on a database or a file. According to an embodiment, the system determines whether to sample a document based on the size of the document. If the document is below a threshold size, the system processes the entire document as supporting information, or else the system performs sampling of the document to limit the size of data that is processed by the system. Sampling of the data overcomes a technical limitation of machine learning based language model that can only process a limited size of structured query inputs. Accordingly, the system according to various embodiments, provides a technical solution to a technical problem encountered while utilizing machine learning based language models such as trained transformer neural networks. The system generates a structured query for a machine learning based language model such as a trained transformer-based neural network including the supporting information, for example, the sampled supporting information with a request to perform certain processing, for example, determine whether a piece of supporting information apply to a control test, whether the control satisfies a constraint represented by a policy, etc. The system receives a response generated by executing the machine learning based language model and may extract structured data from the response. The structured data may indicate whether a particular supporting information apply to a control test, whether the supporting information indicates an exception or a deviation, whether the supporting information indicates a non-occurrence (none of the supporting information satisfies a given constraint). The system determines that a non-occurrence of supporting information for a control test indicates that the control test passed. The system determines based on the response whether the control test is passed based on the supporting information. If the system determines that the supporting information indicates an exception or a deviation, the system generates a prompt for the machine learning-based language model suggesting that this is a problem case and the machine learning-based language model should further analyze the supporting information to determine the problem and suggest a solution. The system summarizes the supporting information with respect to the control test. The system may further summarize all the information with respect to the control since a control may include several control tests. The system may generate recommendations for the user based on the control test results. The recommendation may indicate that additional information of particular type may be needed, a particular type of document may need to be updated with more recent information, and so on.

After completing the three-layer examinations, the system provides a detailed analysis of these documents citing the specific pieces of information used to support the assertion that the control is satisfied or not. Below is the system assessment for the examined control: “The evidence from ‘Test-driven Sprints & Security Iterations.png’, ‘Github Security checks for incoming PRs’, and ‘GitHub Pull Requests and Reviewers-GitHub’ all indicate that there is a process of peer review and approval in place, satisfying one aspect of the control. The evidence from ‘Test-driven Sprints & Security Iterations.png’ also supports the use of test-driven development and security iterations. The evidence from ‘List of merged pull requests.png’ does not provide explicit details about the programming techniques used or the process followed to ensure the code's security, but it does not contradict the other evidence. Therefore, the control is considered satisfied.”

In a complete simulated audit, the system examines all relevant controls using the steps described above. The systema aggregates the control assessments based on the various tests performed. The sum of the control assessments determines the audit result.

According to an embodiment, the system either supports or is built on a multi-tenant distributed system, where each tenant's data is logically partitioned from other tenants. All data is encrypted at rest and in transit. The system maintains four categories of data: a tenant graph describing a tenant's operations configuration, a content store of gathered evidence, an index store of evidence embeddings, and a learned model store. Each data category uses a distinct type of persistent data store services provided by a cloud platform such as AWS (Amazon Web Services) or GCP (Google Cloud Platform). As the system learns about a tenant's environment, that learned knowledge is isolated to the tenant and not used as global knowledge. The system utilizes a layered approach to network security. All of systems core data services reside in a virtual private network with limited outbound access. All inbound traffic goes through a virtual load balancer and firewall. The system may make use of 3rd party hosted machine learning based language models. In this case, the system only uses hosted machine learning based language models that guarantee prompt data, and fine-tuned models are not shared.

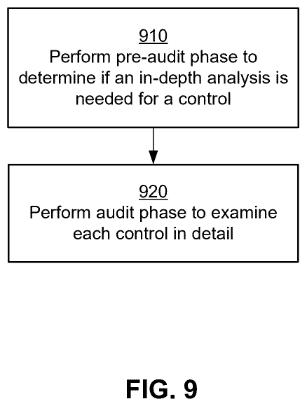

FIG. 9 shows a flow chart illustrating two phase analysis of controls for performing an AI based compliance audit, in accordance with an embodiment. The system performs two-phases: pre-audit phase 910 and audit-check phase 920. Pre-audit checks analyze the overall account state and its readiness for audit. They check if all policies have documentation attached and the templates are filled in, that all SOC2 (or other framework) criteria have controls assigned to them, that all controls have at least one piece of evidence. The system in this stage advises the user not to run an in-depth analysis if the likelihood of failure due to simply absence of evidence is high. The second phase examines each control in detail. It automatically estimates the effectiveness of a given control, by performing various tests. The system performs various types of tests in the audit phase of the analysis as follows.

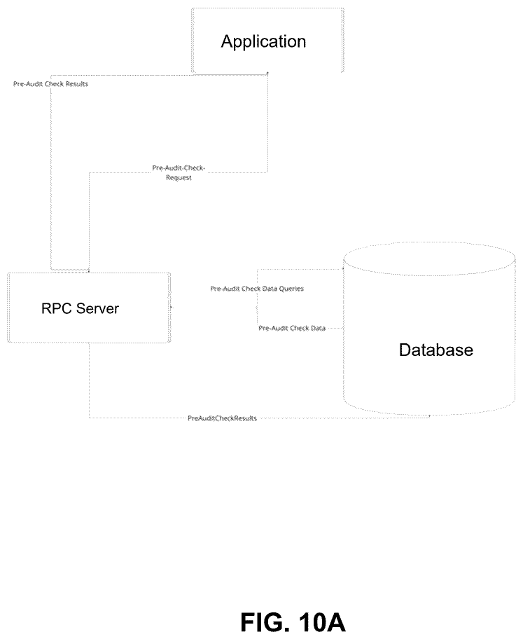

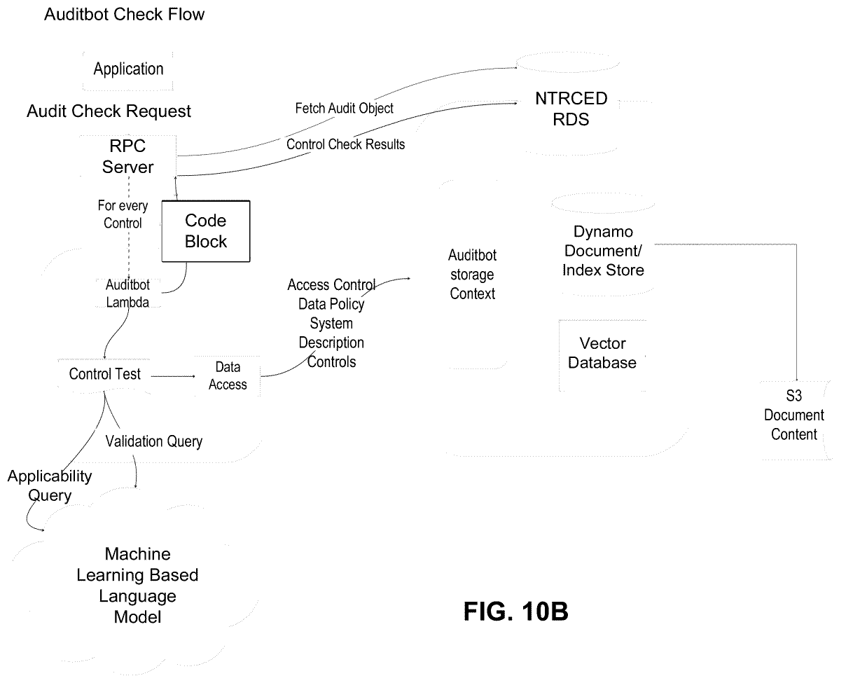

FIG. 10A shows a diagram illustrating the pre-audit phase of AI based compliance audit, in accordance with an embodiment. The pre-audit checks query the database and perform simple checks to see if all controls/policies have at least one document associated with them.

FIG. 10B shows a diagram illustrating the audit phase of AI based compliance audit, in accordance with an embodiment. The system performs scan per control, by querying a SQL database (RDS) to get user content. The content retrieved includes (1) control; objective (2) policy document, and (3) control evidence metadata. The control objective includes the metadata about this particular control objective which includes: (1) required evidence matched for the particular control objective; (2) test procedures matched for the particular control objective; (3) expert guidance matched for the particular control objective. The control evidence metadata includes (1) information obtained from auditor document requests associated with the control; (2) information obtained from automated receptors; and (3) information manually posted by client.

Furthermore, per control the system has access to the pre-indexed/chunked and pre-processed representation of all the evidence and policy documents for the control through a vector store database. According to an embodiment, the indexer is a separate process that automatically indexes/chunks and pre-processes the client content data to be used downstream for various purposes such as AI based compliance audit.

### Process of Artificial Intelligence Based Control Assessment

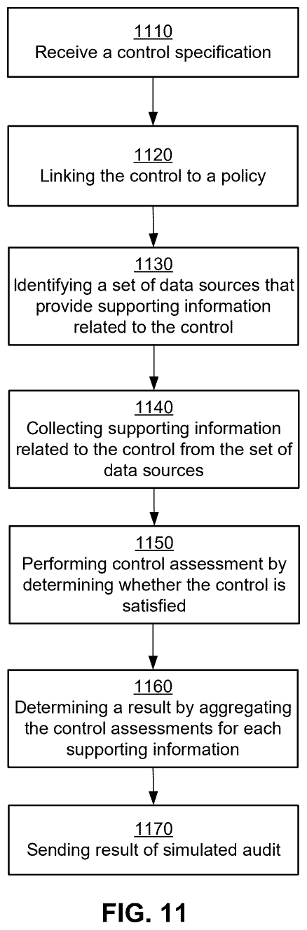

FIG. 11 is a flowchart illustrating an overall process of performing AI based compliance audit, according to an embodiment. The system receives 1110 a control specification that described one or more controls implemented by the organization. Information describing a control may be stored as one or more records in a database. The control specification may be retrieved from the database by executing one or more database queries against the database. A control may comprise an objective statement described using natural language.

The system links 1120 the control specification to a policy specification. The system identifies 1130 a set of data sources that provide support information or evidence related to the controls. The system collects 1140 evidence relevant to the set of controls from the set of data sources. According to an embodiment, the system stores information obtained from the data sources in the vector database 815. The system identifies information from the data sources and converts the information into a vector representation. For example, the vector representation may be vector embeddings generated by a neural network, for example, a transformer neural network trained to process natural language text. According to an embodiment, the transformer-based neural network has been trained on a corpus of domain-specific data using supervised fine-tuning and reinforcement learning. For example, if a data source stores logs generated by systems of an organization, the system stores the logs in the vector database. As another example, if the data source stores screenshots of user interfaces, the system may convert individual screenshots into vector representations and store them in the vector database 815. As another example, the data source stores an architecture diagram of one or more processes and systems, and the vector database stores a vector representation of the architecture diagram. Other types of data formats that the system can process for supporting information includes spreadsheets, documents in various formats such as PDF, Microsoft Word, Excel, CSV (comma separated values), various types if images (GIF, JPEG, PNG, etc.), text files, and so on. As another example, the data source may include audio or video recordings of meetings and the system generates vector representations of the audio or video recordings and stores them in the vector database 815. The system may first transcribe the audio of the audio or video into text form and generate a vector representation of the text transcript in the vector database 815.

The system extracts the support information relevant to a control by generating a vector representation of the control description and executing a query against the vector database 815 requesting retrieval of support information determined to be near the vector representation of the control description based on their vector distances. The vector database executes the query to identify the closest matching support information based on a metric such as a cosine similarity between the vector representation of the control description and the vector representation of the support information. The system may access the text description of the selected support information for providing as input to a machine learning based language model 810.

For the support information collected, the system performs 1150 control assessment by determining based on the evidence, whether the control is satisfied. According to an embodiment, the system generates a structured query input or a prompt for the machine learning based language model 810. The structured query input describes the control and the support information and requests the machine learning based language model 810 to evaluate the control in view of the support information. The structured query input may specify one or more policies and request the machine learning based language model 810 to evaluate the control in view of the policies by determining whether the control causes the systems and users of the organization to comply with the policy. According to an embodiment, the machine learning based language model 810 returns a qualitative measure of the control assessment or a quantitative measure, for example, a numeric score indicating the evaluation of the control. The system aggregates 1160 the control assessments for each supporting information to determine a result, for example, compliance audit result for the control. According to an embodiment, the system processes results provided by the machine learning based language model 810 by applying post-generation parsing rules to extract data fields and generate an interpretable response

According to an embodiment, if the system determines that the control has a poor assessment, the system may further determine the reason for the poor assessment. For example, the system may further generate another structured query input describing the control and the assessment and request the machine learning based language model 810 to determine reasons for the poor assessment. The system may generate a report based on the reasons of poor assessment of the controls.

According to an embodiment, if the system determines that the control has a good assessment, the system may further determine the reason for the good assessment. For example, the system may further generate another structured query input describing the control and the assessment and request the machine learning based language model 810 to determine reasons for the good assessment. For example, the system may request the machine learning based language model 810 to identify the best supporting information indicating that the controls are working properly and helping the organization comply with the policies. The system may generate a report based on the reasons of good assessment of the controls.

The system further aggregates the assessment of the set of controls to determine an overall assessment. For example, the system may determine whether the set of controls overall cause the organization to comply with the policies and procedures.

The system performs one or more actions based on the result. For example, the system may send 1170 the compliance audit result for display via a client device. The system may invoke APIs (application programming interfaces) of one or more tools to perform certain actions. For example, the system may interact with a calendar application to schedule one or more meetings between users related to the compliance audit process. The system may create a ticket in a tracking system related to the compliance audit process. The system may perform a particular type of action if the result indicates that the controls comply with the policies and a different type of action if the results indicate that the controls do not comply with the policies. For example, if the controls comply with the policies, the system may generate a compliance report and send the report in a message to a user indicating the compliance. However, if the system determines that the controls fail to comply with the policies, the system may generate a detailed report indicating the reasons for non-compliance. The system may identify a set of users that are associated with the reasons for non-compliance and send messages to them or schedule a meeting in the calendar. For example, if the non-compliance is caused by actions of a particular team, the system identifies one or more members of that team and sends messages to those members.

### Efficient Evaluation of Controls for a Simulated Inspection

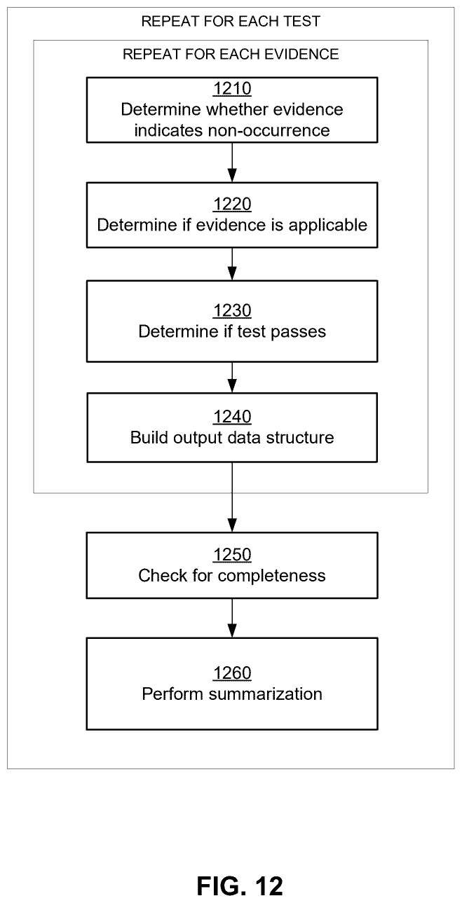

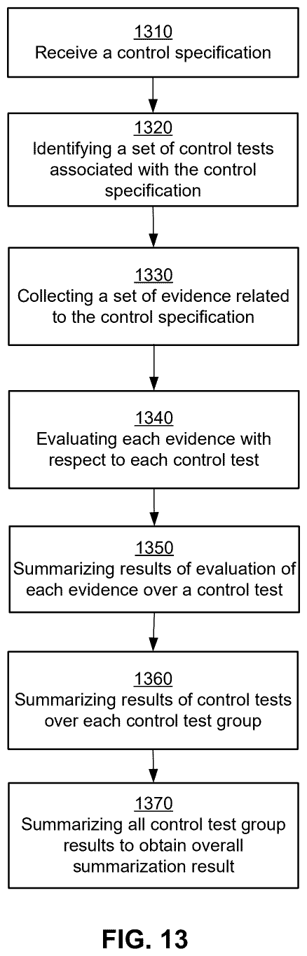

FIG. 12 shows a flowchart illustrating a process for efficiently performing AI based inspection or compliance audit, according to an embodiment. The process illustrated in FIG. 12 is efficient and utilizes fewer computing resources compared to alternative techniques. The process performs the analysis given a control and its objective, suggested evidence, suggested tests, all services, and actual evidence.

The steps of the process are repeated for each test. He system performs steps 1210, 1220, 1230, and 1240 for each piece of evidence. For each piece of evidence, the system examines the evidence to check for various aspects. The system determines 1210 whether the evidence indicates non-occurrence, i.e., the condition that requires the control did not happen. The system determines 1220 whether the evidence is applicable, i.e., does the piece of evidence apply to this particular test. The system determines 1230 whether the test passes, i.e., whether the given piece of evidence passes or fails the given test. If the test fails, the system indicates an exception. The system builds 1240 a data structure with boolean results of the checks and summary text.

The system further checks 1250 for completeness, i.e., the system determines if given the list of applicable evidence, is there sufficient evidence to determine pass/fail on all pieces of this test. The system performs 1260 summarization by determining overall result of the test. If any test fails due to missing data, the system determines if other test results would have been the missing piece that would complement and make the test pass. If so, the system indicates the result as pass. If any test fails for any other reason, the system indicates result as fail. Further the system generates text comprising, for each failure, reasoning and recommendations to fix.

If the system checked 1250 for completeness and determined that all evidence tests pass, the system returns a result pass and a text comprising summary of why all pieces of evidence pass. If the system concludes that the test was incomplete and all evidence is determined to pass, the system indicates result as inconclusive (i.e., system can not tell whether the result is pass). The system further generates text comprising a reason indicating why the evidence is incomplete and recommendations to fix along with a summary of why all of the available evidence passes. The system may use the machine learning based language model to generate text such as reasoning of various types.

According to an embodiment, the system determines spot check results as follows. If any test fails, the system determines the result as fail and generates text comprising details from the particular failing tests. If all tests pass, the system determines the result as pass and generates text comprising summary of text from individual test results. If there are any results that are inconclusive (system cannot tell result), the system indicates result as inconclusive and generates txt from the inclusive test results. If there are any non-occurrences, the system notes them in the response.

The system performs tests to determine whether controls match a policy. Typically, it is a GRC (governance, risk (management), and compliance) requirement that every control is stated in one way or another in its associated policy, and any restatement of the control is without any material differences. A material difference could be the cadence of the control. The system performs tests to determine that available controls match the corresponding policies. According to an embodiment, the system uses a machine learning based language model to determine if a control matches a policy. The system generates a prompt describing the control and a policy and requests the machine learning based language model to determine whether the control matches the policy. A prompt may also be referred to herein as a structured query input for a machine learning based language model. The system receives a response by executing the machine learning based language model and determines based on the response whether the control matches the policy. The description of the control and the policy may use different language or format and the system performs a semantic match using the machine learning based language model to determine that the control and the policy have the same meaning.

This test determines if the control is contained in its associated policy without any material differences. According to an embodiment, all documents associated with the policy are stored in a vector database. To ensure that the control objective is contained in the policy, the system uses cosine similarity on the vector representation of the control objective to fetch the most similar portions of policy documents. The system then supplies these to the machine learning based language model as context along with the control objective and a specific prompt in order to determine if any of the portions of the policy documents contain the control. The system also provides an expert curated definition/list of examples of what constitutes a material difference to the machine learning based language model to determine if the policy contains material differences. The system obtains the response of the machine learning based language model to determine whether the controls match the policy.

Another type of tests performed by the system determine completeness. These tests examine the evidence posted on the control and cross examine it with the recommended or expert curated list of evidence that are required in order to demonstrate the effectiveness (or satisfy) the control. Completeness is a heuristic test that estimates if all the evidence that should be present in order to ascertain the effectiveness of a control is present. The system may use a data store storing metadata describing the various documents storing the supporting information, for example, a SQL database to fetch information describing the evidence, for example, the captions, summaries and/or descriptions of all the evidence attached to the control within a specific date range. For example, a control that concerns perimeter security, the system may look for an architecture diagram or a network diagram as evidence. If the system identifies a document with appropriate title indicating that the document is a network diagram, the system notes that there is a likelihood that the corresponding control has the required evidence. According to an embodiment, the date range may be determined based on the audit or other user supplied settings. Based on the control, the system gets the matched expertly curated list of required evidence that needs to be supplied. The list of evidence and summaries and the curated list of required evidence along with the list of services/service roles the organization uses is provided as part of the prompt to the machine learning based language model. The prompt requests the machine learning based language model to cross reference the two lists and determine if there are any missing requirements of controls or if based on the summaries, each requirement for a control has at least one piece of evidence. The list of services is used to determine if the evidence covers all services as well. For example, if the required evidence is: Encryption Settings for Databases, if the client uses RDS and Dynamo etc., the system searches for evidence for encryption settings for both RDS and Dynamo. In the completeness check the system may just check the availability of a document having matching description and may not analyze the content of the document to see if the document does actually include the required description. The system later analyzes individual supporting documents or information collected to confirm if the requirements of the controls are actually met as per the description in the document. Evidence may be stored in the system as a record in a database that identifies a document representing the evidence and storing the corresponding supporting information. The record may store metadata, for example, a description of the evidence, the title of the document, time/date the document was uploaded, a data source from where the document was obtained.

Another type of tests performed by the system perform spot checks. These tests attempt to perform the test procedures specified for the control. These include expert curated list of tests or test procedures that could be specified by a user, for example, a potential auditor. For each test, spot check examines the evidence and determines if the test has failed. If the test fails, the system attempts to recommend corrective actions to the user as per what information is missing or what piece of evidence shows an exception to the control. According to some embodiments, the spot checks are performed as a fallback option (i.e., a catch all action) if a control does not match any known category. According to other embodiments, spot checks are performed for all controls. According to an embodiment, the system runs test of a sample of supporting information to check if any test fails. If the system does not find any supporting evidence that causes the test to fail, the system assumes the test passes. This process is repeated for all control tests.

The system performs spot check as the most data intensive test and examines each evidence in detail. The system fetches the objective matched list of test procedures associated with the control objective as part of spot check. For each test procedure, the system examines each piece of evidence and attempts to determine the following properties: (1) Is the evidence applicable to the specific test procedure; (2) does the evidence demonstrate a non-occurrence; (3) does the evidence contain an exception/deviation; (4) extraction of the relevant information contained in the evidence with respect to control, as detailed as possible.

The system determines the way each evidence is examined by the mime type of the document as well as the size of the document. If the document is small (number of tokens) and fits within the context window of the machine learning based language model, the system uses the entire document as part of the context for the document examination prompt. If the document is larger than a threshold value, for example, larger than a predetermine percent (e.g., 70%) of the context window. The system may use 70% of the context window as a heuristic guess since the machine learning based language model window also contains the response.

If the document is a free text such as pdf/txt/md file, the system uses the indexed chunks (usually paragraphs etc.) from the index store, takes the top k most relevant document chunks as determined by cosine similarity to the control objective and uses them as context for the query.

If the document is tabular data, such as .csv or .xlsx file, the system breaks the document into chunks by making sure to respect the row boundary, subsamples a number (for example, 500 rows) in the document, and then examines each chunk of the document one by one extracting the relevant data, and summarizing all the chunks in a final summary for the evidence.

After the system examines all the evidence associated with the control and creates a summary of pass/fail results per test, the system determines associated attributions and corrective actions if necessary.

Once the system determines the summaries and the features of the evidence extracted, the system then determines if per test procedure, the set of applicable evidence is complete, i.e. if all the pieces of evidence needed to perform the test are available. If the system determines that all the pieces of evidence needed to perform the test are available, then the system checks if all of the pieces of evidence taken as a whole satisfy the test by examining the summaries/extracted data. According to an embodiment, the system uses summaries for this purpose because examining all evidence at once may not fit into the context window of most machine learning based language models. This also allows the system to perform an approximation of cross referencing evidence which may be required in some cases. Note, that performing exact cross references would require a cross product of all the evidence, which is computationally very costly. Therefore, by examining the extracted summary/relevant information for the control, the system can approximate a cross reference process.

If the particular test procedure is satisfied, the system records the applicable evidence that was used to demonstrate that the test procedure was satisfied. The system uses this as an attribution for the result. If the test is not satisfied, the system recommends a corrective action. The system determines the corrective action based on the step at which the test was unsatisfied. If none of the pieces of evidence show an exception but the system does not have the complete set, the system recommends adding particular information. If a particular piece of evidence shows an exception (e.g., one user does not have MFA enabled) the system uses this as attribution since the system has the exact piece of evidence where this exception was found.

Each test combines expert curated knowledge about the control matched to the control by similarity on the control objective.

The tests maybe in priority order. If the control is not in the policy from a GRC perspective the system determines that there is a fundamental failure, and there is no need to go further in examining the details of the control. If the control does not have the complete recommended set of evidence, the system determines that there is no need to examine each evidence in detail. Furthermore, if the system determines that there is a sufficient set of evidence, the system examines the control and attempt to perform the tests.

Furthermore, the system shows a control is effective by demonstrating the negation of its failure, i.e., the system performs a logical De Morgan's law, that in order for all the evidence to satisfy the control, the system (or an auditor) needs to show no evidence is missing, and that none of the evidence is showing the control is in exception.

As an example, a policy may specify constraints related to maintaining backup copies of information, software, and systems. For example, the policy constraint may specify that backup copies of information, software, and systems must be maintained and regularly tested to enable recovery from loss of data or systems. The policy statement may specify that rules are established to determine requirements for adopting information security controls during disruption; plans are developed, implemented, tested, reviewed, and evaluated to maintain or restore security of information or critical processes following interruption or failure; security of information are restored at the required level and required timeframe. The control specifies that backup copies of information, software, and systems are maintained and regularly tested to enable recovery from loss of data or systems. Examples of control tests include (1) verify that the data backup and restore procedure documents exists and are up to date and outline steps for baking up and restoring data, (2) confirm that backup event logs are being captured for each backup, (3) verify that alert configurations are in place to notify relevant personnel of backup failures, and (4) validate that the data backup and restore procedures are tested at least annually and meet recovery time objectives specified. Examples of evidence include (1) data and backup and restore procedures document, (2) backup event logs that record outcome of each backup operation, (3) alert configurations for failed backups, (4) documentation of the most recent annual test of data backup and restore procedures. The evidence or supporting information may include an unstructured document describing annual data backup and restore test with a date of the document; screen shots of backup tools, system logs, backup images, messages and notifications related to backups, and so on. The system is able to handle a large amount of unstructured information in a variety of formats and in a comprehensive manner that is not possible manually. The system performs steps that simulate an audit process in a manner that is thorough and comprehensive and deals with much more data with an accuracy and comprehensiveness than can be processed by a human. The system generates an execution plan comprising a number of steps to perform the audit simulation. The system performs individual steps with the help of a machine learning based language model.

Accordingly, the system performs following steps as part of the execution plan for the simulated execution: (1) The system determines whether a control matches constraints of the system, for example, constraints specified by a policy. The system generates explanations of why the control supports the policy. (2) The system checks controls for completeness to determine whether all supporting information relevant to the controls tests of the control is available. The system generates explanation as to how the evidence or supporting information is complete, for example, the details of the documents available as evidence. In the above example, the system may describe that the evidence includes documents detailing tests of data backup and restore procedures, backup event logs, alert configurations for failed backups, backup configuration settings, and so on. (3) The system performs spot checks to determine whether all supporting information or evidence passes the required control tests of the control. If the spot checks are not satisfied the system generates an explanation of why the supporting information fails the control tests. The system generates prompts that ask specific questions related to each evidence and executes the prompt using a machine learning based language model to generate a response based on the execution of the machine learning based language model: for example, is the evidence applicable to the specific test procedure, does the evidence demonstrate non-occurrence, does the evidence contain an exception or deviation, does the evidence include information relevant to the control, and so on. As an example, the system may describe that the control objective of maintaining and regularly testing backup copies to enable recovery from data loss or system failure is not satisfied based on the evidence as there are significant gaps in the evidence. The gaps may be present due to parsing issues that prevent a thorough examination of the necessary documents and logs. The system may identify specific issues, for example, absence of comprehensive data backup and restore process description, lack of backup event logs, unverified alert configurations for backup failures, insufficient evidence to confirm annual testing of backup procedures, and so on. The system may generate recommendations for addressing these gaps using machine learning-based language models. For example, a recommendation may suggest ensuring that all critical documents and logs are accessible and properly formatted for review, backup and restore procedures should be updated and documented, alert configurations should be implemented comprehensive logs of backup events should be maintained, and annual tests of backup procedures should be documented clearly to demonstrate their effectiveness and alignment with recovery objectives.

If the spot checks indicate that the evidence passes the required tests the system generates explanation of sport checks. The system may generate description stating that the control objective is fully satisfied, for example, the control objective regarding maintenance and regular testing of backup copies of information, software, and systems to enable recovery from loss of data or systems is fully satisfied based on the collective evidence provided and each control test has been met as follows: evidence includes comprehensive documentation such as disaster recovery plan and backup configurations; the system includes detailed logs and alerts, demonstrating that the backup events logs are captured for each scheduled backup; documentation and system logs verify that alert configurations are in place to notify relevant personnel of backup failures, evidence such as documentation of annual data backup and restore tests confirms that backup and restore procedures and performed regularly. The system may describe that the evidence collectively supports the satisfaction of each control test with no gaps or failure noted.

### Tree Based Summarization of Control Test Results

FIG. 12 shows a flowchart illustrating a process for aggregating control test results, according to an embodiment. The system receives 1310 a control specification associated with a compliance audit. The system identifies 1320 a set of control tests associated with the control specification. The system collects 1330 a set of evidence related to the control specification. For each evidence and for each control test, the system evaluates 1340 the evidence with respect to the control test. For each control test from the set of tests, the system summarizes 1350 the results of evaluating each evidence applicable to the control test with respect to the control test. For each control test group, the system obtains a control test group result by summarizing 1360 results of control tests belonging to the control test group. The system summarizes 1370 all control test group results to obtain an overall summarization result. The system sends the overall summarization result for display via a client device.

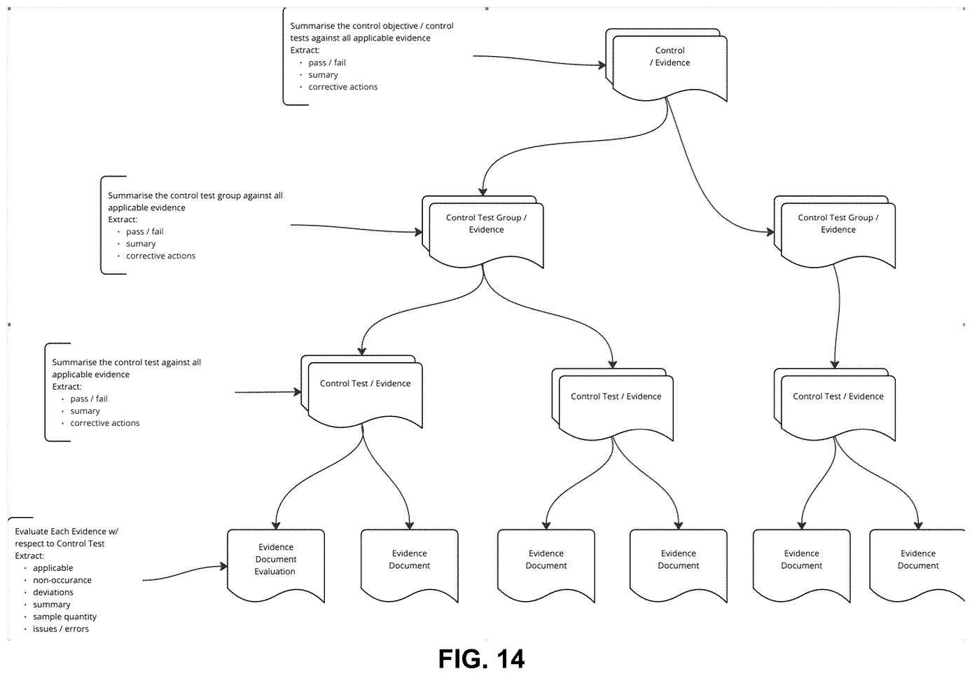

FIG. 14 illustrates a tree data structure for storing summaries for performing spot check, in accordance with an embodiment. The system evaluates each evidence and control test pairing. The result of evaluation of each evidence and control test pairing forms the leaf nodes of the tree. At the next (higher) level of the tree, the system summarizes each control test and stores the result. At the next (higher) level, the system stores the information of the control test group. The test group is referred to as either or tests. In some cases, an auditor requests to see the presence of x or y. For example, either the customer has rule based access control (RBAC) matrix or another system for tracking role/user assignments. The system stores as the last level of summarization, control summarization information.

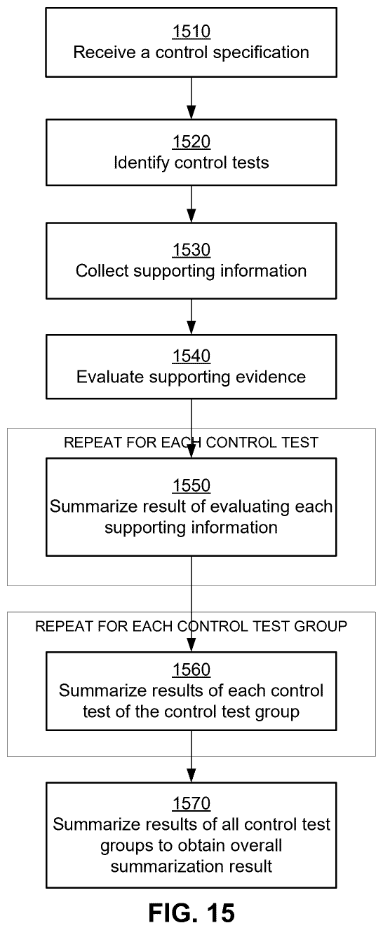

FIG. 15 shows the overall process of summarization of control test results, according to an embodiment. The steps may be performed by a system, for example, the service control analysis system 100. The steps may be performed in an order different from that indicated herein.

The system receives 1510 a control specification comprising a description of a set of controls. The system identifies 1520 a set of control tests associated with the set of controls. For example, the controls may comprise a set of control test groups, each control test group comprising a set of control tests. The system collects 1530 a set of supporting information or evidence related to the set of controls. Each control test may have a set of evidence. The evidence may be in various formats including documents, images, logs, and so on.

The system evaluates for each supporting information, and for each control test, the supporting information with respect to the control test. According to an embodiment, the system evaluates a particular supporting information with respect to a control test by determining whether the supporting information indicates that a condition required by the control failed to occur. According to an embodiment, the system evaluates a particular supporting information with respect to a control test by determining whether the supporting information is applicable to the control test. According to an embodiment, the system evaluates a particular supporting information with respect to a control test by determining whether the supporting information passes the control test. According to an embodiment, the system evaluates a particular supporting information with respect to a control test by building an output data structure based on the result of the control test.

For each control test from the set of control tests, the system summarizes 1550 the results of evaluating each supporting information applicable to the control test with respect to the control test. For each control test group, the system obtains a control test group result by summarizing 1560 results of control tests belonging to the control test group. The system further summarizes 1570 all control test group results to obtain an overall summarization result. The system may send the overall summarization result to a client device. Alternatively, the system may perform one or more actions based on the summary of the overall results. For example, the system may identify a set of users and schedule an event on a calendar, for example, a meeting involving a set of users. The system may generate a recommendation based on the overall summary and send to one or more users. For example, if the overall summary indicates failure of one or more control test groups, the system may recommend collecting additional evidence for control tests of those test groups. The recommendation may indicate that additional information of particular type may be needed, a particular type of document may need to be updated with more recent information, and so on.

According to an embodiment, the system summarizes the results of evaluating a particular supporting information using machine learning based language models. The system generating a structured query input, i.e., a prompt describing the results of evaluating the particular supporting information with as request to generate summary of the results. The system inputs the structured query input into a machine learning based language model, for example, a trained transformer-based neural network. The system processes an output sequence generated by the machine learning based language model. The output sequence comprises the summary of the results.

According to an embodiment, the structured query input is formatted according to a pre-defined schema for interaction with the trained transformer-based neural network. The transformer-based neural network has been trained on a corpus of data using supervised fine-tuning and reinforcement learning. The system may process the output sequence by applying post-generation parsing rules to extract data fields and generate an interpretable response.

The effective summarization of the results allows consolidation of the actions taken in response to the control tests and efficiently executing the actions. For example, taking actions for individual control test results may result in duplication of actions since there can be a large number of control tests being evaluated. For example, the system may be required to report multiple results or perform multiple actions such as scheduling events or requesting different types of evidence to be collected. Consolidating the results allows the system to eliminate duplicate actions, thereby performing fewer actions. Accordingly, the effective summarization of results improves the efficiency of execution of the system and improves consumption of computing resources of the system including processing resources and networking resources utilized for performing the actions.

### Applications

According to an embodiment, the system obtains SOC (service organization controls) reports of various organizations and uses data-mining techniques to find criteria and subservice organization controls for services used by an organization or external services functionally similar to them. A SOC report represents written documentation of the internal controls that are likely to be relevant to an audit of the organization. SOC reports are designed to help service organizations that provide services to other entities, build trust and confidence in the service performed and controls related to the services through a report reviewed and validated by an independent auditor. A SOC report allows a reviewer to verify that an organization is following some specific best practices.

Techniques disclosed herein can be used for various applications. For example, organizations generate compliance reports describing service controls implemented for their services. Services used by the organization may invoke external services. External services may also be referred to as subservices. Organizations may perform several tasks using external services, ranging from tracking of the human resources processes, payroll, hosting databases, and various applications used by the organization. These external services may be referred to as subservices.

In order to implement a design of a system, and to be able to provide guarantees about its security and reliability, an organization may assume that the subservice organization implements a set of service controls. These service controls may also be referred to as complementary subservice organizational controls (CSOCS). The system according to various embodiments allows users to automatically create a list of service controls which are assumed to be implemented by the corresponding subservices used by the organization. The system infers a list of service controls likely to have been implemented by external services used within an organization. These external services are discovered by the system when the list of services of an organization are provided as input to the system. From the received set of services, the system determines various criteria with their corresponding CSOCS to be used in the CSOC section of a compliance report, as-is or as a starting point.

Using this collection of previously used CSOCs, the system uses natural language processing techniques disclosed herein to group, summarize and extract the most salient service controls for a given service. The system accordingly provides a list of complementary controls based on SOC reports of similar organizations. These lists may be used for generating a SOC report for the organization.

### Technical Improvements

According to an embodiment, the system performs tuning of the machine learning based models used for performing various tasks such as generating summaries, analyzing controls and policies, and so on. The machine learning based model may be a machine learning based language model, for example, a large language model (LLM). According to an embodiment, the machine learning based language model is a transformer-based neural network that is pretrained using large corpus of data, for example, massive amounts of text data, often involving billions of words or text units. The large amount of training data from various data sources allows the machine learning based model to generate outputs for many tasks. The machine learning based model may have a significant number of parameters in a transformer-based neural network, for example, at least 1 billion, at least 15 billion, at least 135 billion, at least 175 billion, at least 500 billion, at least 1 trillion, at least 1.5 trillion parameters.

Since the machine learning based language model has significant parameter size and the amount of computational power for inference or training the machine learning based language model is high, the machine learning based language model may be deployed on an infrastructure configured with, for example, supercomputers that provide enhanced computing capability (e.g., graphic processor units) for training or deploying deep neural network models. In one instance, the machine learning based language model may be trained and deployed or hosted on a cloud infrastructure service. The machine learning based language model may be pre-trained by system or one or more entities different from the organization running the system. The machine learning based language model may be trained on a large amount of data from various data sources. For example, the data sources include websites, articles, posts on the web, and the like. From this massive amount of data coupled with the computing power of machine learning based language models, the machine learning based language model is able to perform various tasks and synthesize and formulate output responses based on information extracted from the training data.

The pretrained machine learning based language model may be further fine tuned by retraining the machine learning based language model using data specific to the organization, for example, documents of the organization, logs of the organization, database records of the data that may be proprietary to the organization, and so on. The retraining process causes the parameters of the machine learning based language model to be modified based on data of the organization, for example, using a technique such as gradient descent.

The model is represented by the parameters of the machine learning based language model as well as the prompt that is provided as input to the machine learning based language model. For example, the prompt represents a structured query input that may follow specific format based on a predefined template. The system tunes the model by tuning the structured query input, for example, by modifying the template or using a template that is specific to a context, for example, a template for the organization. According to an embodiment, the system tunes the model by modifying the structured query input for different contexts. A prompt provided as input to a machine learning based language model may also be referred to herein as a structured query input for the machine learning based language model. Tuning the models improves the accuracy of the results obtained by the processes disclosed herein for example processes for evaluation of controls of an organization.

The system improves the overall efficiency of execution of the processes disclosed herein, for example, the processes for evaluation of controls by extracting relevant support information from a large set of heterogeneous data sources of the organization. The data sources may include logs of the organization, documents of the organization, screenshots of user interfaces, messages used by various communication channels of the organization such as emails, chat, messages, and so on. The amount of data processes for an organization can be significantly large. Furthermore, the size of the data as well as the heterogeneous nature of the data sources makes it difficult for a human to process or a conventional database or search engine to process. The system converts information extracted from various data sources into vector representations, for example, vector embeddings generated by a neural network such as a transformer-based neural network. The system stores the vector representations in a vector database that allows searching for related information based on vector distances, for example, based on cosine similarity metrics. The system receives an input for querying the vector database and converts the input query into a vector representation. The system uses vector distances of data stored in the vector database from the vector representation of the input query to identify information relevant to the input query that is near the vector representation of the input query based on vector distances. For example, the system may select support information stored in the vector database that is within a threshold vector distance of the vector representation of the input query. Alternatively, the system may rank support information stored in the vector database based on their vector distances from the vector representation of the input query and select the top K results based on their vector distances from the vector representation of the input query.

Machine learning based language models have a technical limitation of the size of the query input that the machine learning based language model can process. For example, a machine learning based language model can only process structured query input that is below a threshold size. The use of vector database for filtering the support information relevant to the input query allows the system to build structured query input that is within the size limitation of the machine learning based language model and includes the optimal information relevant for answering the structured query using the machine learning based language model. Including large amounts of information in the structured query input prevents the machine learning based language model from processing the structures query input since it exceeds the size limitation of the structured query input processed by the machine learning based language model. Furthermore, arbitrarily filtering the support information that is included in the structured query input results in generating poor or incorrect results. Therefore, the techniques disclosed herein improve the accuracy of the results generated by the system such as accurate evaluation of controls. A system may attempt to achieve accurate results by repeatedly querying the machine learning based language model using different subsets of support information extracted from the vector database. However, repeatedly executing the machine learning based language model for multiple inputs is computationally expensive. The techniques disclosed achieve accurate results with fewer invocations of the machine learning based language model, thereby improving the computational efficiency of the processes disclosed herein and also efficiently utilizing computations resources including processor resources as well as network resources if the query and the results are communicated over the network to a machine learning based language model running on a remote system. Accordingly, the techniques disclosed herein provide a technical solution to a technical problem inherent to machine learning based language models such as large language models.

### Alternative Embodiments

It is to be understood that the Figures and descriptions of the present invention have been simplified to illustrate elements that are relevant for a clear understanding of the present invention, while eliminating, for the purpose of clarity, many other elements found in a typical system. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for generating reports based on instrumented software through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method, comprising:
receiving description of a set of controls and a set of constraints;
identifying a set of data sources storing information associated with the set of controls;
storing in a vector database, vector representations of information obtained from the set of data sources;
for each control from the set of controls:
extracting supporting information related to the control from the vector database based on vector distances,
generating a structured query input describing the control and the supporting information, the structured query input formatted according to a pre-defined schema for interaction with a trained transformer-based neural network,
inputting the structured query input into the trained transformer-based neural network, and
processing an output sequence generated by the trained transformer-based neural network to obtain a result indicating whether the control satisfies a constraint from the set of constraints;
generate evaluation of the set of controls based on results obtained for the set of controls; and
performing a target action based on the evaluation of the set of controls.

2. The computer-implemented method of claim 1, further comprising:
executing a series of classifiers to identify tests applicable to the set of controls, and
executing the tests identified.

3. The computer-implemented method of claim 1, wherein a data source provides one or more screenshots of user interfaces of applications, wherein the vector database stores a vector representation of the one or more screenshots.

4. The computer-implemented method of claim 1, wherein a data source stores an audio recording, wherein the vector database stores a vector representation of a transcript of the audio recording.

5. The computer-implemented method of claim 1, further comprising:
sampling a set of entities, and
cross-referencing entities from the set of entities against support information.

6. The computer-implemented method of claim 1, wherein the trained transformer-based neural network has been trained on a corpus of domain-specific data using supervised fine-tuning and reinforcement learning.

7. The computer-implemented method of claim 1, wherein processing an output sequence generated by the trained transformer-based neural network comprises applying post-generation parsing rules to extract data fields and generate an interpretable response.

8. A non-transitory computer readable storage medium storing instructions that when executed by one or more computer processors, cause the one or more computer processors to perform steps comprising:
receiving description of a set of controls and a set of constraints;
identifying a set of data sources storing information associated with the set of controls;
storing in a vector database, vector representations of information obtained from the set of data sources;
for each control from the set of controls:
extracting supporting information related to the control from the vector database based on vector distances,
generating a structured query input describing the control and the supporting information, the structured query input formatted according to a pre-defined schema for interaction with a trained transformer-based neural network,
inputting the structured query input into the trained transformer-based neural network, and
processing an output sequence generated by the trained transformer-based neural network to obtain a result indicating whether the control satisfies a constraint from the set of constraints;
generate evaluation of the set of controls based on results obtained for the set of controls; and
performing a target action based on the evaluation of the set of controls.

9. The non-transitory computer readable storage medium of claim 8, wherein the instructions when executed by one or more computer processors, further cause the one or more computer processors to perform steps comprising:
executing a series of classifiers to identify tests applicable to the set of controls, and
executing the tests identified.

10. The non-transitory computer readable storage medium of claim 8, wherein a data source provides one or more screenshots of user interfaces of applications, wherein the vector database stores a vector representation of the one or more screenshots.

11. The non-transitory computer readable storage medium of claim 8, wherein a data source stores an audio recording, wherein the vector database stores a vector representation of a transcript of the audio recording.

12. The non-transitory computer readable storage medium of claim 8, wherein the instructions when executed by one or more computer processors, further cause the one or more computer processors to perform steps comprising:
sampling a set of entities, and
cross-referencing entities from the set of entities against support information.

13. The non-transitory computer readable storage medium of claim 8, wherein the trained transformer-based neural network has been trained on a corpus of domain-specific data using supervised fine-tuning and reinforcement learning.

14. The non-transitory computer readable storage medium of claim 8, wherein processing an output sequence generated by the trained transformer-based neural network comprises applying post-generation parsing rules to extract data fields and generate an interpretable response.

15. A computer system comprising:
one or more computer processors; and
a non-transitory computer readable storage medium storing instructions that when executed by the one or more computer processors, cause the one or more computer processors to perform steps comprising:
receiving description of a set of controls and a set of constraints;
identifying a set of data sources storing information associated with the set of controls;
storing in a vector database, vector representations of information obtained from the set of data sources;
for each control from the set of controls:
extracting supporting information related to the control from the vector database based on vector distances,
generating a structured query input describing the control and the supporting information, the structured query input formatted according to a pre-defined schema for interaction with a trained transformer-based neural network,
inputting the structured query input into the trained transformer-based neural network, and
processing an output sequence generated by the trained transformer-based neural network to obtain a result indicating whether the control satisfies a constraint from the set of constraints;
generate evaluation of the set of controls based on results obtained for the set of controls; and
performing a target action based on the evaluation of the set of controls.

16. The computer system of claim 15, wherein the instructions when executed by one or more computer processors, further cause the one or more computer processors to perform steps comprising:
executing a series of classifiers to identify tests applicable to the set of controls, and
executing the tests identified.

17. The computer system of claim 15, wherein a data source provides one or more screenshots of user interfaces of applications, wherein the vector database stores a vector representation of the one or more screenshots.

18. The computer system of claim 15, wherein a data source stores an audio recording, wherein the vector database stores a vector representation of a transcript of the audio recording.

19. The computer system of claim 15, wherein the instructions when executed by one or more computer processors, further cause the one or more computer processors to perform steps comprising:
sampling a set of entities, and
cross-referencing entities from the set of entities against support information.

20. The computer system of claim 15, wherein the trained transformer-based neural network has been trained on a corpus of domain-specific data using supervised fine-tuning and reinforcement learning.
